(19) United States
(12) Patent Application Publication
(10) Pub. No.: US 2011/0029476 A1
(43) Pub. Date: Feb. 3, 2011

(54) INDICATING RELATIONSHIPS AMONG TEXT DOCUMENTS INCLUDING A PATENT BASED ON CHARACTERISTICS OF THE TEXT DOCUMENTS

(76) Inventors: Kas Kasravi, Bloomfield, MI (US); Marie Risov, Bloomfield Hills, MI (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/511,547

(22) Filed: Jul. 29, 2009

(51) Int. Cl. G06N 7/04; G06F 7/06; G06F 17/30

(52) U.S. Cl. 706/54; 707/E17.014

(57) ABSTRACT

Plural characteristics of text documents are extracted, where the plural characteristics include citations to or from other text documents and at least one other characteristic. At least one of the text documents is a patent. Each of the text documents is associated with a corresponding collection of the plural characteristics. An output is generated using the collections of the plural characteristics, where the output indicates relationships among at least a subset of the text documents including the patent based on the collections of the plural characteristics.

### BACKGROUND

Certain documents, such as patents, may contain relatively complex information. Patents can contain both technical and legal information. Comparing documents that contain relatively complex information can be challenging, particularly when there are a relatively large number of such documents. There are millions of patents, and ascertaining similarities between patents can be a tedious and labor-intensive task.

### BRIEF DESCRIPTION OF THE DRAWINGS

Some embodiments of the invention are described with respect to the following figures:

FIG. 1 illustrates generation of characteristics associated with a patent, according to an embodiment;

FIG. 2 illustrates text mining of a patent to generate concepts for use in a process according to an embodiment;

FIG. 3 illustrates generation of characteristics associated with a patent, according to another embodiment;

FIG. 4 illustrates a flow for comparing a target patent to reference patents, according to an embodiment;

FIG. 5 illustrates an example output that illustrates patents and various characteristics associated with a target patent, derived according to an embodiment of the invention;

FIG. 6 illustrates another example output that depicts relationships among patents and other characteristics, according to another embodiment; and

FIG. 7 is a block diagram of an exemplary system that incorporates an embodiment of the invention.

### DETAILED DESCRIPTION

In addition to being tedious and time-consuming, attempting to find similar text documents such as patents can result in many false positives (documents identified as being similar when in fact they are not) and false negatives (documents identified as not being similar when in fact they are similar). For example, when performing a prior art search for a target patent, not being able to obtain accurate results may mean that relevant prior art such as patents and publications may not be found.

In accordance with some embodiments, an automated mechanism is provided to determine similarities between patents (and/or other text documents) based on multiple characteristics of the patents. For example, similarities can be determined among patents. As yet another example, similarities can be determined between a patent and one or more other types of text documents, such as scientific articles, technical articles, or other publications. A text document refers to any document that contains text. A “patent” can refer to a granted patent, a patent application (whether published or not), an invention registration, a provisional application, or any other document describing an invention that is to be submitted to a patent office. The similarity determination algorithm is a multivariate analysis that considers multiple variables (characteristics). Examples of characteristics that are considered to determine similarities between patents include citations associated with the patents, classifications of the patents, dates of the patents, concepts associated with the patents, and other characteristics. If a patent is being compared with another type of text document, selected characteristics can be extracted from the other type of text document to compare against the characteristics of the patent. Examples of selected characteristics extracted from the other type of text document include citations, publication dates, concepts, and an inferred patent class (which can be based on the subject matter described in the text document). The inferred patent class can be determined either manually or by performing a linguistic analysis of the text document.

Concepts associated with a patent can be derived by analyzing one or more sections of the patent, including the abstract, claims, summary, detailed description, drawings, title, inventor list, and so forth.

Citations associated with a patent refer to citations to other references (such as other patents or publications) that are either contained in the detailed description section of the patent, or in the cover page of the patent that contains a list of references cited during prosecution of the patent. The foregoing citations are considered backward citations. Citations associated with a target patent can also include forward citations, which are citations from other patents (or other documents) to the target patent.

Concepts and citations can also similarly be associated with other types of text documents. The ensuing discussion refers primarily to finding similarities among patents. However, similar techniques can be applied to find similarities among text documents, where at least one of the text documents is a patent while the remaining text documents are other type(s) of documents.

FIG. 1 illustrates a process of extracting characteristics of a patent 100. The patent 100 is retrieved from a database, such as the patent database maintained by the U.S. Patent and Trademark Office, a database maintained by an enterprise such as a company, educational organization, government agency, and so forth, or any other type of database that contains patents.

The patent 100 is provided to a patent pre-processor 102, which extracts various characteristics from the patent 100, including dates 106, citations 108, patent classes 110, and concepts 112. Examples of dates 106 include the filing date, issue date, publication date, and so forth. Citations 108 can be backward and/or forward citations. Patent classes include primary classes and sub-classes, such as classes defined by the U.S. Patent Classification or the International Patent Classification.

The characteristics of the patent 100 that have been extracted by the patent pre-processor 102 are stored in a patent data store 114. Extraction of characteristics of patents can be iteratively performed for all patents retrieved from a database to build up the patent data store 114, which will be used for performing the similarity analysis according to some embodiments, as discussed further below.

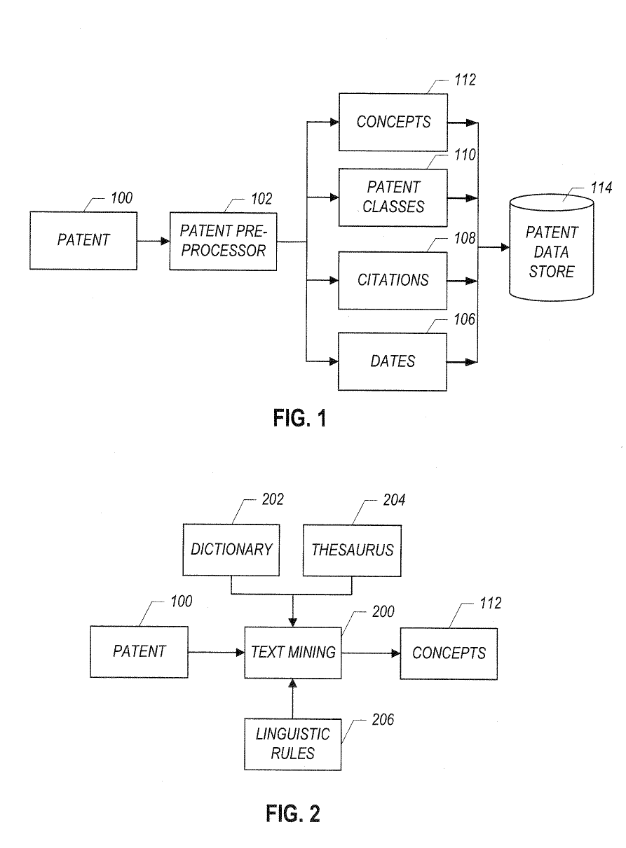

To derive the concepts 112, the patent pre-processor 102 applies text mining, which is illustrated in FIG. 2. There are various text mining techniques available that performs semantic analysis and tagging. Examples of available products that can perform text mining include the Lucene open source text analysis product, text analysis software from ClearForest, or the TextAnalyst text mining software. Other text mining components can be employed for analyzing section(s) of patents to extract concepts, in other implementations.

As shown in FIG. 2, a text mining component 200 of the pre-processor 102 is applied to the patent 100 produce the concepts 112. The text mining component 200 can apply text mining to one or more sections of the patent 100, including the abstract, claims, detailed description, and so forth. The text mining component 200 leverages various sources, including one or more dictionaries 202, one or more thesaurus' 204, and linguistic rules 206. The dictionaries, thesaurus', and linguistic rules can be employed to ascertain senses of words contained in the patent. Note that a word can have several possible meanings (senses) depending upon the context that the word is used in. Identifying the proper senses allows proper concepts to be derived.

In addition to identifying the concepts 112, the frequency and impact of the concepts can also be determined to indicate which concepts are more important than other concepts for the corresponding patent 100.

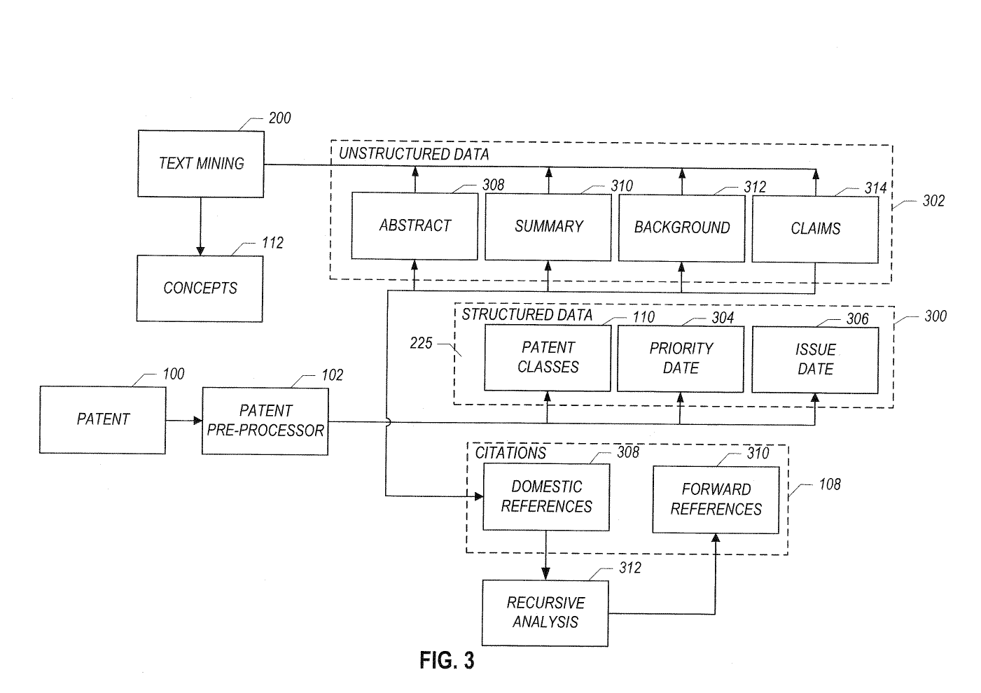

FIG. 3 illustrates a process according to another embodiment for extracting characteristics of the patent 100. In the embodiment of FIG. 3, the patent 100 is divided into several parts, including citations 108, structured data 300, and unstructured data 302. The structured data 300 refers to data within the patent 100 that have predefined formats. Examples of structured data 300 include patent classes 110, and dates such as a priority date 304 and an issue date 306 of the patent 100. The unstructured data 302 refers to data in the patent that has no predefined format. For example, the abstract 308, summary 310, background 312, and claims 314 of the patent 100 contains content that is free form-in other words, a user is able to include as much data or as little data in whatever form in these sections to describe the subject matter of the patent.

As further shown in FIG. 3, the unstructured data 302 is provided to the text mining component 200, which produces concepts 112 as discussed above. Although the text mining component 200 is shown separately from the patent pre-processor 102, it is noted that the text mining component 200 can actually be part of the patent pre-processor 102.

The citations 108 shown in FIG. 3 include domestic (backward) references 308 and forward references 310. A domestic reference 308 is a reference to another patent or other document contained in the patent 100. A forward reference 310 refers to a reference made by other patents or other documents to the patent 100. Recursive analysis 312 is applied to determine the forward references. The recursive analysis 312 involves analyzing citations of other patents to find references in such other patents to the patent 100.

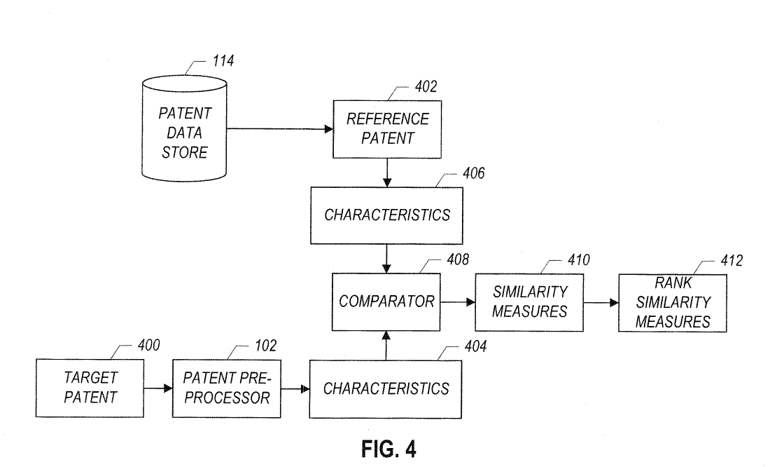

FIG. 4 illustrates a process of identifying patents (reference patents) in the patent data store 114 that are similar to a target patent 400. The patent data store 114 contains information relating to the patents and associated characteristics, as extracted according to one of the techniques described above in connection with FIGS. 1-3. Reference patents 402 are iteratively extracted from the patent data store 114 one at a time for the for the purpose of comparison with the target patent 400.

The target patent 400 is provided to the patent pre-processor 102, which extracts various characteristics 404 of the target patent 400. The characteristics 404 are the same characteristics (dates 106, citations 108, patent classes 110, and concepts 112) discussed above.

The characteristics 406 of the reference patent 402 are also extracted from the patent data store 114. The characteristics 406 of the patent reference are then compared (408) to the characteristics 404 of the target patent 400 by a comparator 408, which outputs a similarity measure 410 indicating the similarity between the reference patent 402 and the target patent 400. In an alternative embodiment, instead of the data store 114 storing reference patents, the data store 114 can store other types of text documents, from which characteristics can be extracted for comparison to characteristics 404 of the target patent 400.

One example technique for comparing the reference patent characteristics 406 and the target patent characteristics 404 is described below. In one implementation, reference patent characteristics 406 and target patent characteristics 404 are essentially vectorized representations of the patents, where each element of the vector quantifies a single characteristics such as date, patent class, or key concept. The goal of the comparator 408 is to compute the distance between characteristics 406 and characteristics 404. Naturally, the shorter the distance, the more similar the two patents. If this distance is zero, then the two patents are essentially describing the same subject matter.

More specifically, the characteristic vectors include a reference patent characteristic vector, which is represented as RCi, where Ci is the value of characteristic i for reference patent R. The characteristic vectors further include a target patent characteristic vector, which is represented as TCi, where Ci is the value of characteristic i for target patent T.

Thus, the distance D between the two vectors RCi and TCi for n characteristics can be defined as:

D=ΣAi(f(TCi−RCi)) ∀ i=1 to n, (Eq. 1)

where, Ai is a coefficient for characteristic i, and f(TCi−RCi) is a function of the difference between the two respective characteristics based on the type of the data involved (e.g., number, date, symbol).

For example, if the characteristic data is numerical, then f(TCi−RCi) is the simple difference between the two numbers, e.g., f(5−3)=2. As another example, if the characteristic data is temporal, then the difference can be measured in the desired time increment such as days or months, e.g., f(1/5/09−12/25/08)=11 days. The choice of the time increment may depend on the desired granularity of the analysis—for patent analysis, the time increment selected may be days.

As yet another example, if the characteristic data is symbolic, then the difference can be measured based on heuristics. One simple example of a heuristic is True/False, e.g., f(Iron−Aluminum)=False, but f(Iron−Iron)=True. More complex heuristics may also be employed, such as by using synonyms, e.g., f(Iron−Steel)=True. Instead of True/False, one may use other values having greater granularity (e.g., values such as Very Close, Close, Equal, Far, Very Far). Such values may be mapped to a numerical range for subsequent computation, e.g., True=1, False=0; Very Close=2, Close=1, Equal=0, Far=1, Very Far=2.

The coefficient Ai in Eq. 1 above can be determined manually or based on data analysis such as regression analysis against known data sets. The purpose of Ai is to allocate an appropriate weight to a corresponding patent characteristic. For example, the coefficient value for a keyword “Material” may be a small value such as 0.4, indicating a small impact on the measure of distance D computed by Eq. 1, but another coefficient value for the characteristic Patent Class may be a higher value such as 4, indicating a much greater contribution of Patent Class to distance than the keyword “Material.”

The purpose of Eq. 1 for computing distance D is to assess the contextual similarity of two patents, as a collective function of the sum of the characteristics.

The comparison depicted in FIG. 4 is repeated for other reference patents 402 in the patent data store 114. The comparisons between characteristics 406 of the reference patents 402 and the characteristics 404 of the target patent 400 result in corresponding similarity measures 410 for respective reference patents 402.

In some implementations, the similarity measures 110 can then be ranked (at 412). Ranking the similarity measures 110 allows a determination of which of the reference patents 402 are more similar to the target patent 400. The similarity measures 410 in one implementation are the distances D computed according to Eq. 1. Smaller values of D are ranked higher than higher values of D, since a shorter distance indicates greater similarity.

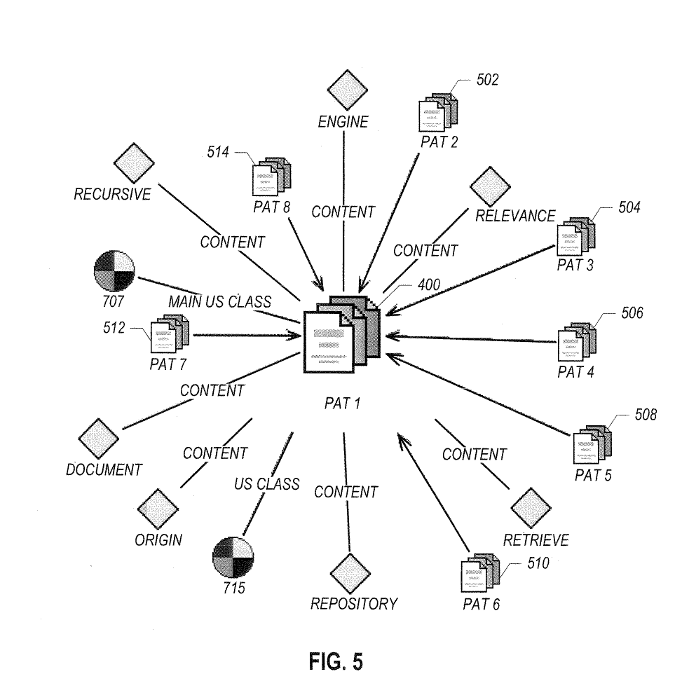

FIG. 5 shows an example link diagram that includes a cluster of the target patent 400 that is linked to similar patents and characteristics. The characteristics linked to the target patent 400 include some of the characteristics derived by the patent pre-processor 102 as described above. The immediate neighbor patents linked to the target patent 400 in the cluster are those patents determined to be similar to the target patent 400, as determined according to FIG. 4.

The target patent 400 is generally in the middle of the cluster. Similar patents 502, 504, 506, 508, 510, 512 and 514 are provided around and linked to the target patent 400. The similar patents 502-514 included in the cluster may be the seven patents that are the most similar to the target patent 400, based on the similarity measures 410 computed in FIG. 4, for example.

The characteristics in the cluster that are linked to the target patent 400 include concepts associated with the target patent 400, where the concepts are represented by diamonds in FIG. 5. The example concepts associated with the target patent 400 shown in FIG. 5 include “engine,” “relevance,” “retrieve,” “repository,” “origin,” “document,” and “recursive.” In addition to concepts, other characteristics that can be depicted in the cluster include patent classes, represented by circles in FIG. 5.

Effectively, the link diagram shown in FIG. 5 contains the target patent 400 and similar patents as well related characteristics, all represented by different icons. The similar patents are represented with a first icon, concepts are represented with a different icon, and patent classes are represented with yet another icon. If additional characteristics are to be shown in the link diagram of FIG. 5, such additional characteristics may be represented with different icons.

Note that in alternative implementations, a link diagram can also show other types text documents that are similar to the target patent 400.

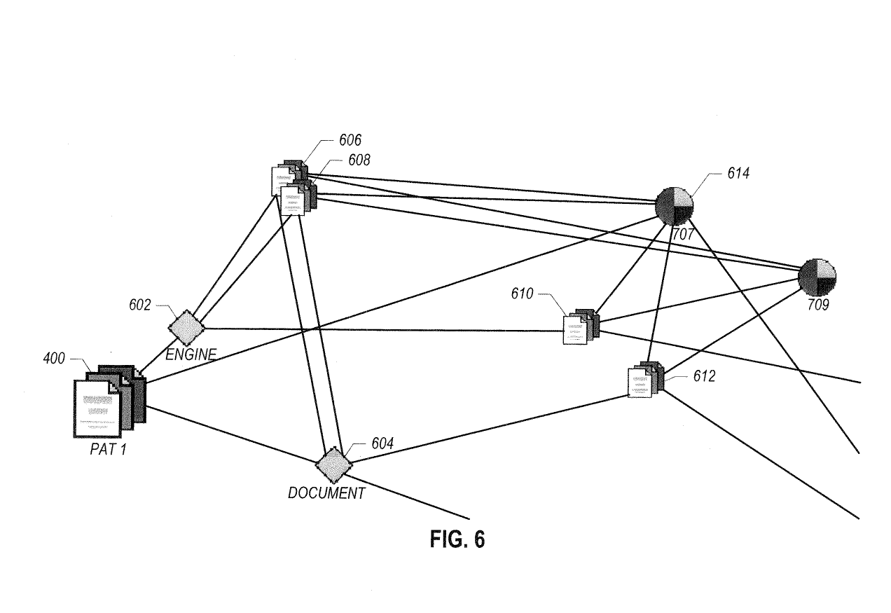

The link diagram of FIG. 5 shows the immediate neighbors (similar patents) of the target patent 400. If desired, a user can select that deeper connections be shown to multiple levels. FIG. 6 shows an example of a diagram that illustrates the target patent as well as characteristics associated with the target patent 400. In addition, the link diagram of FIG. 6 shows additional patents that are related to the characteristics of the target patent 400. In one example, the link diagram shown in FIG. 6 can be produced by a link clustering tool, such as that provided by I2 Ltd. (e.g., I2 Analyst's Notebook).

In the example of FIG. 6, concepts associated with the target patent 400 include “engine” and “document,” which are represented by icons 602 and 604. In turn, patents 606, 608, and 610 are related to the “engine” concept, and patent 612 is related to “document” concept (604). Moreover, target patents 610 and 612 are also related to class 707, as represented by icon 614, which is also related to the target patent 400.

The link diagram of FIG. 6 thus shows characteristics associated with the target patent 400, and further patents that are associated with such characteristics (but not directly linked to the target patent 400). In other words, the patents 606, 608, 610 and 612 are not directly related to the target patent 400, but instead are related through the characteristics associated with the patent 400.

It is noted that FIG. 6 shows a subset of all the relationships that can exist when a link diagram is used to show relationships to deeper than one level. It is noted that when going to two levels or more, there can be a relatively large number of patents and characteristics shown in the link diagram, which may make the link diagram unreadable by a user. FIG. 6 shows a portion of such a detailed link diagram that may have been selected by a user to focus on just a part of the larger link diagram.

The links shown in FIG. 6 are made among similar concepts, patent classes, and citations. Note that dates can be used to filter patents to such that only patents that fall within predetermined date ranges are shown.

By using the automated mechanism of identifying similar patents according to some embodiments, similarities among patents can be detected more rapidly than using a manual process. Moreover, an interactive visual environment is provided to allow the user to further investigate similarities among target patents.

Although the foregoing has referred to finding characteristics and patents that are similar to a target patent, note that the techniques above can be applied to find patents that are similar to a particular concept or a particular class. As a result, techniques according to some embodiments can be used for performing patent searching regarding particular concepts, infringement detection based on concepts, and trend analysis regarding certain concepts.

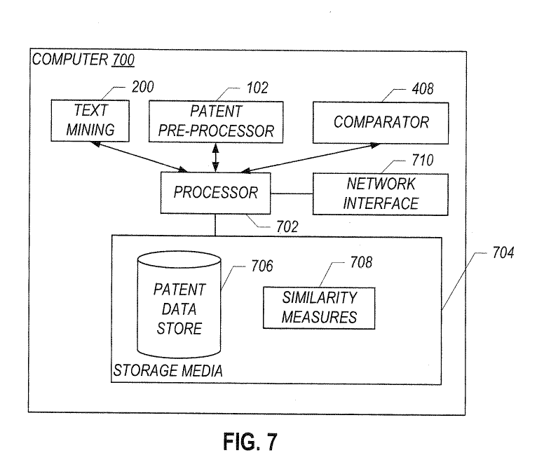

FIG. 7 shows an exemplary computer 700 in which some embodiments of the invention can be incorporated. The computer 700 includes the patent pre-processor 102, the text mining component 200, and the comparator 408, which may be software modules executable on a processor 702 of the computer 700. The text mining component and comparator 408 can be part of the patent pre-processor 102, or they can be separate from the patent pre-processor 102.

Moreover, the processor 702 is connected to storage media 704 (which can be implemented with one or more disk-based storage devices and/or one or more integrated circuit or semiconductor memory devices), which contain a patent data store 706 and similarity measures 708.

The computer 700 also includes a network interface 710 to allow the computer 700 to communicate over a data network, such as to access a patent database that contains patents or other types of documents. Note that the computer 700 can refer to a single computer node or to multiple computer nodes.

Instructions of the software described above (including the patent pre-processor 102, text mining component 200, and comparator 408) are loaded for execution on the processor 702. The processor includes microprocessors, microcontrollers, processor modules or subsystems (including one or more microprocessors or microcontrollers), or other control or computing devices. As used here, a “processor” can refer to a single component or to plural components (e.g., one or plural CPUs on one or plural computers).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
extracting, by a processor, plural characteristics of text documents, wherein at least one of the text documents is a patent, wherein the plural characteristics include citations to or from other text documents and at least one other characteristic, and wherein each of the text documents is associated with a corresponding collection of the plural characteristics; and
generating, by the processor, an output using the collections of the plural characteristics, wherein the output indicates relationships among at least a subset of the text documents including the patent based on the collections of the plural characteristics.

2. The method of claim 1, wherein the at least one other characteristic includes a patent class.

3. The method of claim 1, wherein extracting the plural characteristics comprises extracting characteristics that further include dates and concepts.

4. The method of claim 3, further comprising applying text mining on one or more sections of each of the text documents to derive the concepts.

5. The method of claim 4, wherein the one or more sections include one or more of an abstract, a summary, claims, a title, and a detailed description.

6. The method of claim 1, further comprising:
comparing the characteristics of the patent to the collection of the plural characteristics of each of other text documents; and
determining similarity measures based on the comparing.

7. The method of claim 6, wherein generating the output comprises generating the output linking the patent to other text documents identified to be similar based on the similarity measures.

8. The method of claim 7, wherein generating the output comprises generating the output further linking selected characteristics to the patent.

9. The method of claim 8, wherein generating the output comprises generating the output further linking additional text documents linked to the selected characteristics but not linked to the patent.

10. A computer comprising:
a storage media to store a database of text documents including at least one patent; and
a processor to:
extract characteristics from the patent, wherein the characteristics include citations to or from other text documents and at least one other characteristic;
compare characteristics of each of a set of text documents to the characteristics of the patent; and
based on the comparing, producing a visual cluster of the patent and ones of the text documents in the set determined to be similar to the patent.

11. The computer of claim 10, wherein the citations include one or more of forward and backward citations.

12. The computer of claim 10, wherein the set of text documents includes a set of patents, and wherein the characteristics that are compared further include patent classes.

13. The computer of claim 12, wherein the characteristics that are compared further include dates.

14. The computer of claim 12, wherein the characteristics that are compared further include concepts derived from content of the patents.

15. The computer of claim 14, wherein the concepts are derived based on text mining applied to the patents.

16. The computer of claim 14, wherein the at least one other characteristic includes a patent class, wherein the patent class for a non-patent text document is inferred based on subject matter described in the non-patent text document.

17. An article comprising at least one computer-readable storage medium containing instructions that upon execution cause a processor to:
extract plural characteristics of text documents, wherein the plural characteristics include citations to or from other text documents and a patent class;
compare the plural characteristics of the text documents;
generate a link diagram that links a target one of the text documents to other text documents identified to be similar based on the comparing.

18. The article of claim 17, wherein the plural characteristics further include concepts extracted from the text documents.

19. The article of claim 17, wherein the text documents include patents.
